(19) United States
(12) Patent Application Publication
(10) Pub. No.: US 2026/0277634 A1
(43) Pub. Date: Sep. 17, 2026

(54) SYSTEM AND/OR METHOD FOR ELECTRONICALLY PROCESSING OF HIERARCHICALLY SORTED CONTENT STORED IN MEMORY

(71) Applicant: HTS, LLC, Durango, CO (US)

(72) Inventor: Jeffery Lamonde Carter, Durango, CO (US)

(21) Appl. No.: 19/565,279

(22) Filed: Mar. 12, 2026

Related U.S. Application Data
(60) Provisional application No. 63/771,606, filed on Mar. 13, 2025.

(51) Int. Cl. G06F 9/451; G06F 3/0482; G06F 3/0484

(52) U.S. Cl. CPC G06F 9/451; G06F 3/0482; G06F 3/0484

(57) ABSTRACT

Disclosed are a system, method and apparatus for electronically processing hierarchically sorted electronic content stored in a memory. A menu of a plurality of analytical tools on the display device may be presented on a display device responsive to selection of a node via a graphical user interface (GUI). Responsive to selection of an analytical tool of the presented plurality of analytical tools, the selected analytical tool may be applied to data objects in the memory linked to the selected node.

This application claims the benefit of priority to U.S. Provisional Patent Appl. Ser. No. 63/771,606 titled “SYSTEM AND/OR METHOD FOR ELECTRONICALLY PROCESSING OF HIERARCHICALLY SORTED CONTENT STORED IN MEMORY,” filed Mar. 13, 2025 and incorporated herein by reference in its entirety.

### BACKGROUND

### 1. Field

This disclosure relates to methods and/or techniques for electronically processing hierarchically sorted content stored in a memory.

### 2. Information

Techniques for analysis of data obtained from search and retrieval providers typically includes an end user downloading and formatting retrieved data into a spreadsheet. Application of analytical tools using a manual process may take significant man hours for manipulation of the formatted data to yield meaningful results.

### BRIEF DESCRIPTION OF DRAWINGS

Claimed subject matter is particularly pointed out and distinctly claimed in the concluding portion of the specification. However, both as to organization and/or method of operation, together with objects, features, and/or advantages thereof, it may best be understood by reference to the following detailed description if read with the accompanying drawings in which:

FIGS. 1A and 1B are diagrams of a depiction of a hierarchical graph presented on a display device integrated with a graphical user interface (GUI), according to an embodiment;

FIG. 2 is a diagram of a depiction of a menu of a plurality of analytical tools presented on a display device integrated with a GUI, according to particular embodiments;

FIG. 3A is a diagram of a depiction of a report from execution of an analytical tool, according to an embodiment;

FIG. 3B is a diagram of a depiction of a portion of a spreadsheet report showing items in an intersection of data objects linked to multiple nodes in a hierarchical graph, according to an embodiment;

FIGS. 4A, 4B and 4C are flow diagrams of processes to electronically processing hierarchically sorted content stored in a memory, according to an embodiment; and

FIG. 5 is a schematic block diagram of an example computing system in accordance with an implementation.

Reference is made in the following detailed description to accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others. Furthermore, structural and/or other changes may be made without departing from claimed subject matter. It should also be noted that directions and/or references, for example, such as up, down, top, bottom, and so on, may be used to facilitate discussion of drawings and are not intended to restrict application of claimed subject matter. Therefore, the following detailed description is not to be taken to limit claimed subject matter and/or equivalents. Further, it is to be understood that other embodiments may be utilized. Also, embodiments have been provided of claimed subject matter and it is noted that, as such, those illustrative embodiments are inventive and/or unconventional; however, claimed subject matter is not limited to embodiments provided primarily for illustrative purposes. Thus, while advantages have been described in connection with illustrative embodiments, claimed subject matter is inventive and/or unconventional for additional reasons not expressly mentioned in connection with those embodiments. In addition, references throughout this specification to “claimed subject matter” refer to subject matter intended to be covered by one or more claims, and are not necessarily intended to refer to a complete claim set, to a particular combination of claim sets (e.g., method claims, apparatus claims, etc.), or to a particular claim.

### DETAILED DESCRIPTION

References throughout this specification to one implementation, an implementation, one embodiment, an embodiment, and/or the like means that a particular feature, structure, characteristic, and/or the like described in relation to a particular implementation and/or embodiment is included in at least one implementation and/or embodiment of claimed subject matter. Thus, appearances of such phrases, for example, in various places throughout this specification are not necessarily intended to refer to the same implementation and/or embodiment or to any one particular implementation and/or embodiment. Furthermore, it is to be understood that particular features, structures, characteristics, and/or the like described are capable of being combined in various ways in one or more implementations and/or embodiments and, therefore, are within intended claim scope. In general, of course, as has always been the case for the specification of a patent application, these and other issues have a potential to vary in a particular context of usage. In other words, throughout the patent application, particular context of description and/or usage provides helpful guidance regarding reasonable inferences to be drawn; however, likewise, “in this context” in general without further qualification refers to the context of the present patent application.

Search results formatted in a flat electronic spreadsheet may be organized by columns, rows and tabs. While spreadsheet formats may be effective for processing, updating and/or retrieving items maintained by row, column and/or tab, spreadsheet formats may be less effective at visually presenting an ontology, taxonomy and/or hierarchical structure of.

According to an embodiment, to assist in storage and/or retrieval of items stored in a physical memory, a computerized system may express features relating to such stored items in a graph including nodes representing data objects and edges connecting such nodes to represent relationships between and/or among such data objects. In this context, the term “graph” as used herein is to mean one or more signals and/or memory states expressing such nodes and edges. In one aspect, features of a graph may be visually presented on a computer screen and/or display device such as a computer screen and/or display device integrated with a graphical user interface (GUI).

In one aspect, an ontology of located/downloaded items may be visually presented (e.g., on a computer screen and/or display device) as a hierarchical graph. Such a hierarchical graph may comprise nodes connected by edges descending from a root node. According to an embodiment, individual nodes in the graph may be electronically linked to a set of data objects maintained in a memory. In one implementation, a child node in the graph descending from a parent node in the graph may be linked to data objects in the memory which are a subset of the data objects in the memory linked to the parent node. The subset of the data objects lined to the child node may be determined according to one or more classification attributes to be defined for the child node.

In one aspect, first user inputs received via a graphical user interface (GUI) integrated with a display device may affect selection of a node in the hierarchical graph. Responsive to selection of the node, a menu of a plurality of analytical tools may be presented on the display device. Second user inputs receive via the GUI may affect selection of an analytical tool of the plurality of the plurality of tools presented on the display device. Responsive to the selection of the analytical tool of the plurality of analytical tools, the selected analytical tool may be applied to data objects in the memory linked to the selected node for computation of an output report.

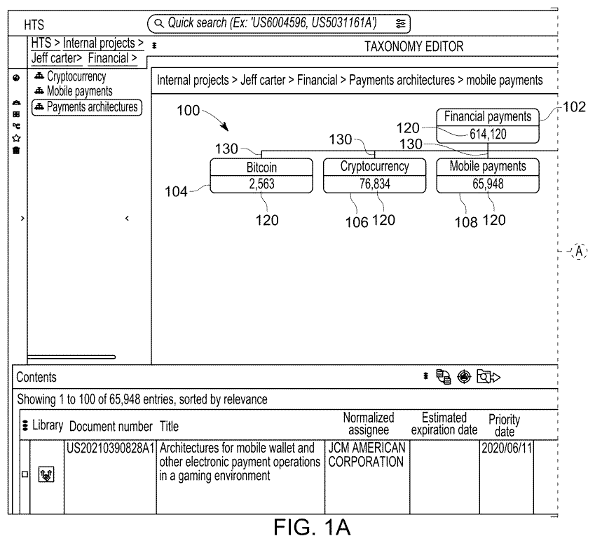

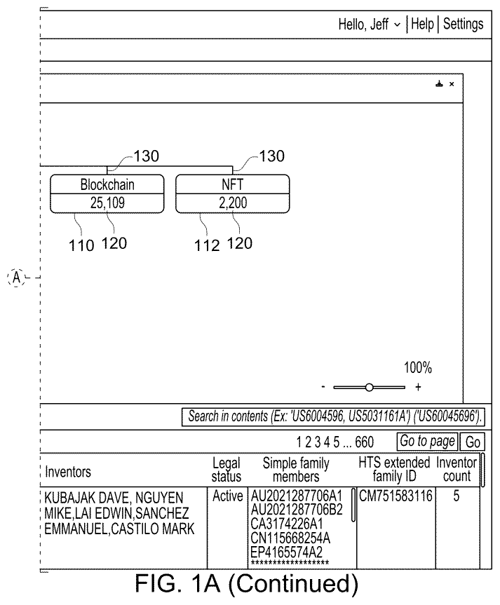

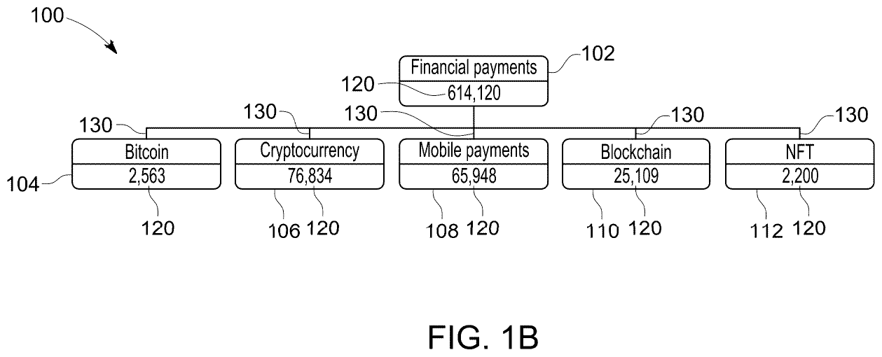

FIGS. 1A and 1B are diagrams of a depiction of a hierarchical graph presented on a display device integrated with a graphical user interface (GUI), according to an embodiment. According to an embodiment, such a graphical user interface may include executable routines and/or drivers to process user inputs from a pointing device (e.g., mouse, trackball, joystick, touch screen, not shown). For example, such a pointing device may be activated by a user to position a cursor over a particular item in an image presented on a display device. In a particular example, nodes 102, 104, 106, 108, 110 and 112 may comprise features that are selectable by placement of a cursor (e.g., using a pointing device) over one of the nodes followed an additional action (e.g., mouse click, pressure on a touchscreen, selection from a trackball or joystick, voice activation etc.).

In the particular illustrated example, node 102 may form a root node which is connected to child nodes 104, 106, 108, 110 and 112 by edges 130 to form a hierarchical graph 100. According to an embodiment, hierarchical graph 100 may represent an ontology, taxonomy and/or hierarchical structure of data objects stored in a memory, such as electronic documents maintained in memory in a suitable format. Here, node 102 is associated with a class of data objects in a classification “financial payments.” Nodes 104, 106, 108, 110 and 112 are associated with objects in subclassifications of data objects in classification “financial payments” associated with node 102. For example, node 104 is associated with data objects in classifications “financial payments” and “bitcoin,” node 106 is associated with data objects in classifications “financial payments” and “cryptocurrency,” node 108 is associated with data objects in classifications “financial payments” and “mobile payments,” node 110 is associated with data objects in classifications “financial payments” and “blockchain,” and node 112 is associated with data objects in classifications “financial payments” and “NFT.”

In a particular implementation, fields/labels 120 indicate a count or enumeration of data objects associated with/linked to respective nodes. According to an embodiment, data objects under the classification “financial payments” associated with node 102 may comprise publications of patents (e.g., issued U.S. patents) in a particular electronic format (e.g., . pdf, docx, XML). For example, in the presently illustrated embodiment, node 102 may be linked to 614,120 publications of issued U.S. patents. In an implementation, via selection of node 102 via a GUI, a user may access any of these 614,120 publications (e.g., for copy, download, viewing on a display device). Likewise, node 104 may be linked to 2,563 publications of issued U.S. patents (a subset of the 614,120 publications of issued U.S. patents linked to node 102 relating to “bitcoin”) similarly accessible via a GUI. Likewise, node 106 may be linked to 76,834 publications of issued U.S. patents (a subset of the 614,120 publications of issued U.S. patents linked to node 102 relating to “cryptocurrency”) similarly accessible via a GUI. Likewise, node 108 may be linked to 65,948 publications of issued U.S. patents (a subset of the 614,120 publications of issued U.S. patents linked to node 102 relating to “mobile payments”) similarly accessible via a GUI. Likewise, node 110 may be linked to 25,109 publications of issued U.S. patents (a subset of the 614,120 publications of issued U.S. patents linked to node 102 relating to “blockchain”) similarly accessible via a GUI. Likewise, node 112 may be linked to 2,200 publications of issued U.S. patents (a subset of the 614,120 publications of issued U.S. patents linked to node 102 relating to “NFT”) similarly accessible via a GUI.

According to an embodiment, data objects linked to a particular node in hierarchical graph 100 may be accessible via a GUI for analysis and/or processing by one or more analytical tools. Such analytical tools may comprise, for example:
Assignee Metrics (3);
Three different analytical methods to characterize assignees.
   Top Assignees
   Rate of Change
   Child Node Analysis
Jurisdiction Metrics (3);
Three different analytical methods to understand jurisdictions.
   Top Jurisdictions
   Rate of Change
   World map
Technology Life Cycle (3);
   Technology Life Cycle, Stages
   Technology Life Cycle, Average Priority Date
   Rejection Analysis, Technology Life Cycle
Technology Cycle Time;
Rejection Analysis (4);
   Licensability
   Technology Life Cycle
   Defensibility
   Defensive Index
Pioneer/Imitator;
Cash Flow Metrics (4);
   Debt Service Coverage Ratio (DSCR)
   Free Cash Flow (FCF)
   Unlevered Free Cash Flow (UFCF)
   Cash and cash equivalents (CCE)
Revenue vs. Patents Filed;
Market Capitalization vs. Patents Filed;
Node summary;
Life Expectancy;
Node Comparison;
Patent Claims Analyzer;
Activity Index;
Top Inventors;
Contributor Metrics (2);
   Contributor Index
   Contributor Analysis
R&D vs. Patents Filed;
Patent Prioritization;
Claim Comparison Tool;
CPC Analysis;
Pressure Test;
Invalidity Tool;
Infringement Tool, just to provide a few examples.

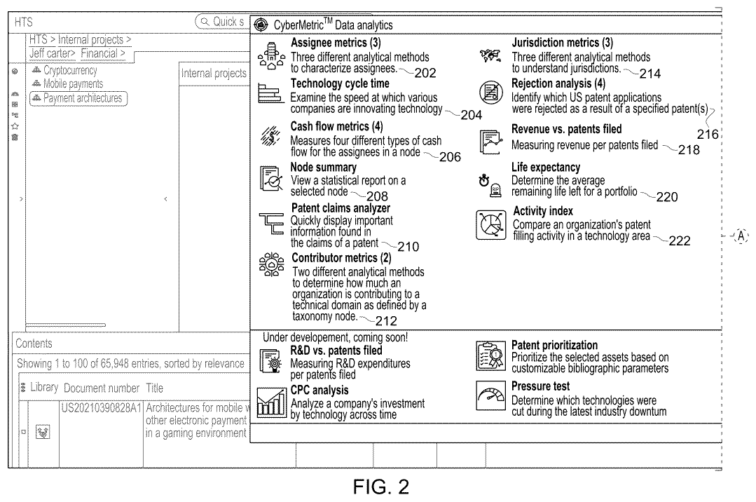

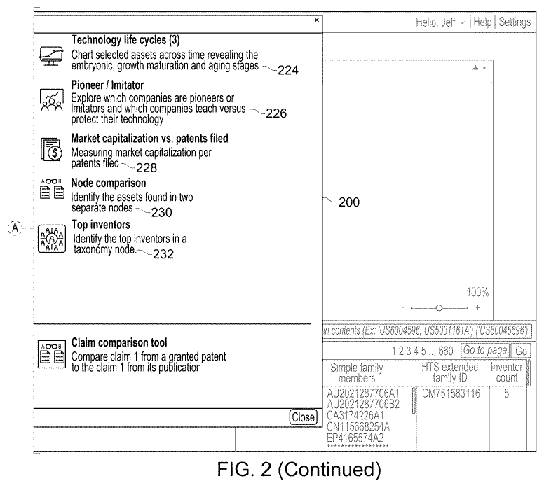

FIG. 2 is a diagram of a depiction of a menu 200 identifying of a plurality of analytical tools presented on a display device integrated with a GUI, according to particular embodiments. In one particular example, menu 200 may be presented in a display device and/or computer screen by placement of a cursor over a node selected in hierarchical graph (e.g., node 102, 104, 106, 108, 110 or 112), followed by an additional action (e.g., mouse right-click, voice activation, joy stick action). Here, menu 200 may list available analytical tools (e.g., identified by icons 202 through 232) that are selectable to process and/or analyze data objects maintained in a memory and linked to the selected node in hierarchical graph 100. If node 102 is the selected node, menu 200 may identify analytical tools that are selectable to process and/or analyze the 614,120 data objects maintained in a memory and linked to node 102. Likewise, if node 104 is the selected node, menu 200 may identify analytical tools that are selectable to process and/or analyze the 2,563 data objects maintained in a memory and linked to node 104. Likewise, if node 106 is the selected node, menu 200 may identify analytical tools that are selectable to process and/or analyze the 76,834 data objects maintained in a memory and linked to node 106. Likewise, if node 108 is the selected node, menu 200 may identify analytical tools that are selectable to process and/or analyze the 65,948 data objects maintained in a memory and linked to node 108. Likewise, if node 110 is the selected node, menu 200 may identify analytical tools that are selectable to process and/or analyze the 25,109 data objects maintained in a memory and linked to node 110. Likewise, if node 112 is the selected node, menu 200 may identify analytical tools that are selectable to process and/or analyze the 2,200 data objects maintained in a memory and linked to node 112.

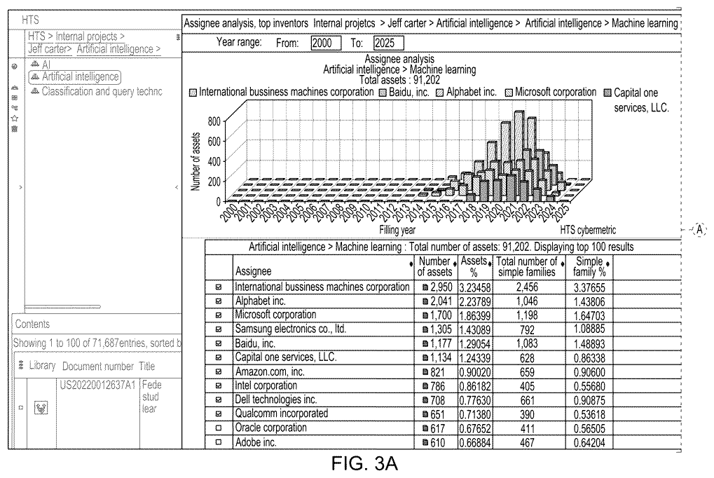

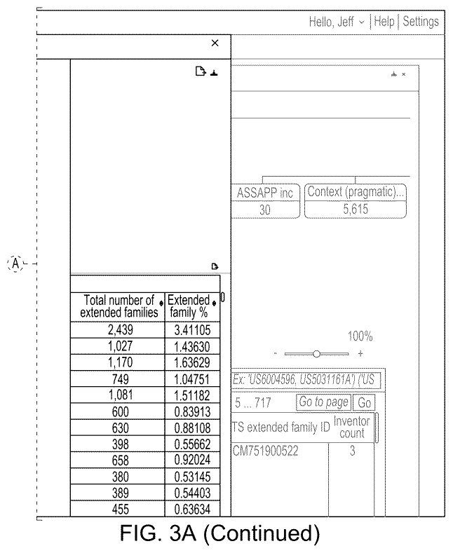

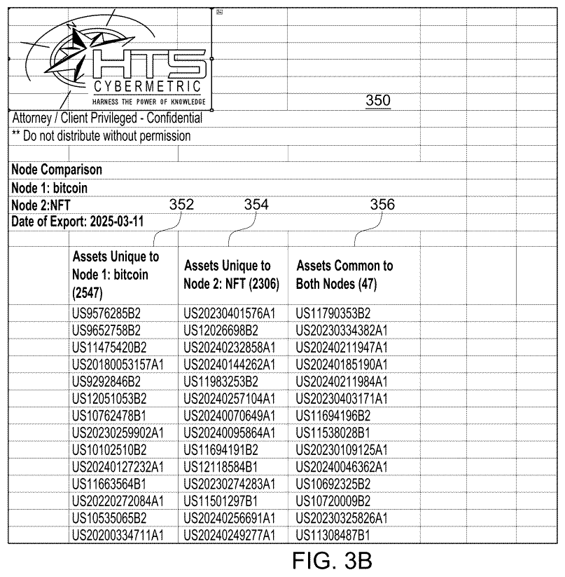

According to an embodiment, a user may take action via a GUI to may initiate application of an analytical tool presented in menu 200 by selection of an appropriate icon (e.g., any of icon 202 through 232). For example, while menu 200 is presented for a particular selected node in hierarchical graph, an icon in menu 200 may be selected to initiate application of an associated analytical tool to process and/or analyze data objects maintained in a memory and linked to the selected node. According to an embodiment, selection of an icon in menu 200 may initiate access to data objects maintained in a memory and linked to the selected node to be used as inputs to one or more computer programs for execution of one or more analytical tools corresponding to the selected icon. In one implementation, the data objects may be copied to a buffer formed in memory and formatted for further process by execution by the one or more analytical tools. In another implementation, links, identifiers and/or handles to the data items may be provided as inputs to the one or more computer programs for execution of the one or more analytical tools. FIG. 3A is a diagram of a depiction of a report from execution of an analytical tool to analyze and/or process from selection of an icon in menu to analyze and/or process data objects linked to a selected node in hierarchical graph 100.

FIG. 3B is a diagram of a depiction of a portion of a spreadsheet report showing items in an intersection of data objects linked to multiple nodes in a hierarchical graph, according to an embodiment. In an implementation, for example, multiple nodes in hierarchical graph may be selected in succession via a GUI for generating a report of data objects linked to all nodes selected in succession. Such a report may identify and/or list data objects that are in an intersection of respective sets of data objects linked to nodes that are selected in a sequence of selections. In the particular example illustrated in FIG. 3B, nodes 104 and 112 may be selected through a GUI (e.g., positioning a cursor over node 104 and making a first mouse click followed by positioning the cursor over node 112 and making a second mouse click). Following selection of nodes 104 and 112 in sequence, an additional action may be taken via the GUI to generate report 350 shown in FIG. 3B. Here, data objects linked to node 104 (classified as relating to “bitcoin”) are shown listed in column 352 and data objects linked to node 112 (classified as relating to “NFT”) are shown listed in column 354. Data objects lined to both nodes 104 and 112 (classified as relating to “bitcoin” and “NFT”) are shown listed in column 356.

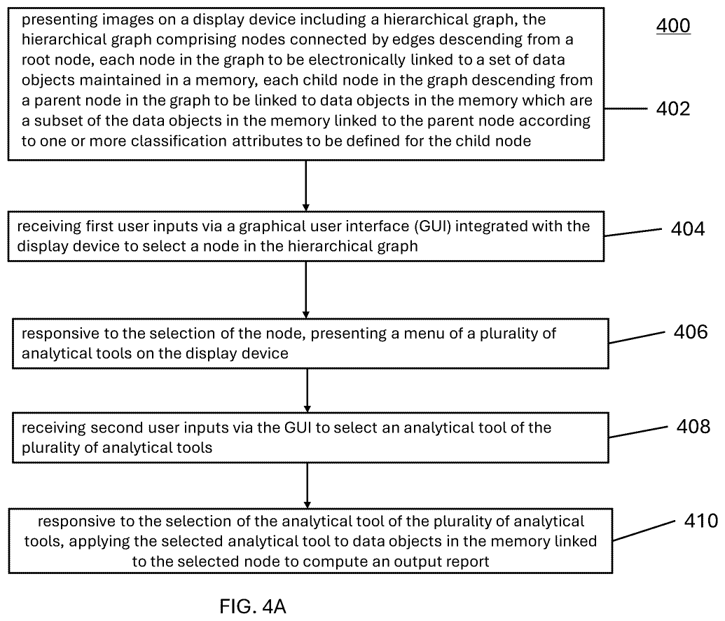

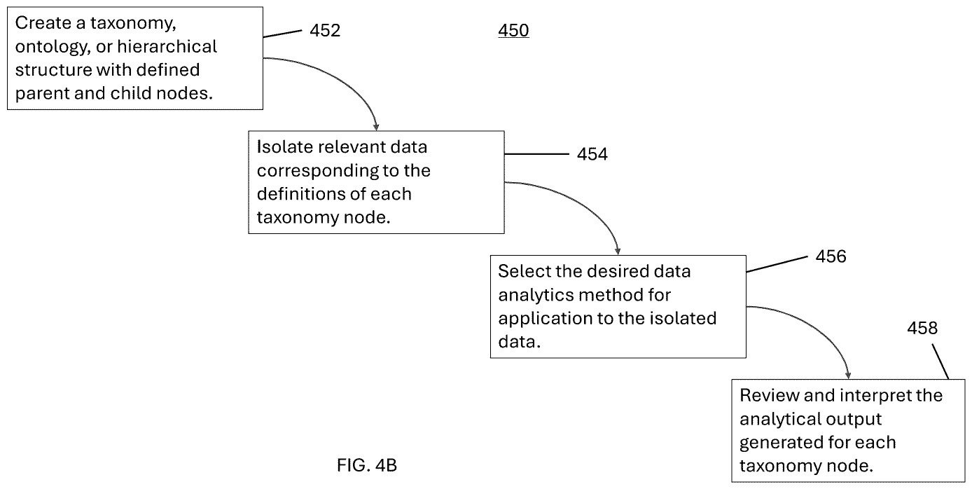

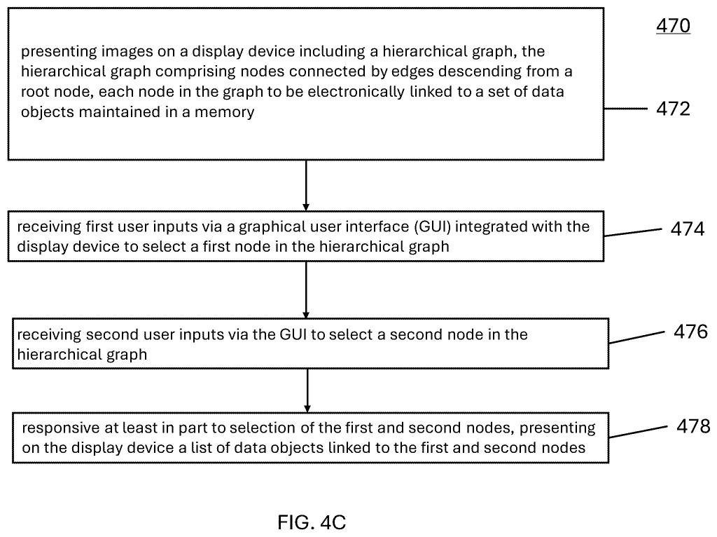

FIGS. 4A, 4B and 4C are flow diagrams of processes to electronically processing hierarchically sorted content stored in a memory, according to an embodiment. Processes 400 and 470 may be executed in connection with processing user inputs received from a GUI, for example. Blocks 402 and 472 may comprise presentation of a hierarchical graph such as hierarchical graph 100 shown in FIGS. 1A and 1B. In one particular embodiment, at least some of the nodes in the hierarchical graph may be linked to respective data objects via one more universal resource identifiers (URIs). In another particular implementation, at least some of the nodes of the hierarchical graph may be linked to respective data objects via addresses to electronic documents local to computing device hosting the GUI. In yet another implementation, data objects linked to at least some of the nodes in the hierarchical graph comprise publications of U.S. patents in an electronic format (e.g., .pdf, docx, xml, etc.).

Blocks 404 and 474 may comprise processing inputs from a GUI initiated by, for example, positioning of a cursor over a node in hierarchical graph 100 followed by an additional action (e.g., mouse click or pressure on a touchscreen). In one implementation data objects linked to a node in the hierarchical graph comprise electronic documents which are accessible, at least in part, via the GUI by selection of the node.

Block 406 (FIG. 4A) may comprise processing a selection made at block 404 to initiate presentation of a menu in a display device and/or computer screen, such as menu 200 (FIG. 2). Block 408 may comprise processing inputs from a GUI for to select an analytical toot to be applied to data objects linked to the node selected at block 404. For example, block 408 may comprise processing a selection from positioning of a cursor over an icon shown in menu 200, followed by an additional action such as a mouse click to initiate.

According to an embodiment, responsive to a selection of an analytical tool at block 408, block 410 may apply/execute the selected analytical tool to process and/or analyze data objects maintained in a memory that are linked to a node selected at block 404. For example, block 410 may comprise access of data objects stored memory that are linked to the node selected at block 404 (e.g., by copying the accessed data object to a buffer memory and/or providing handles/identifiers), followed by presentation of results from execution of the analytical tool in FIG. 3A (e.g., presentation of results on a display device integrated with the GUI).

In one particular implementation, block 410 may apply a selected analytical tool to data objects in the memory linked to the node selected at block 404 by initiating access to one or more web services via a universal resource identifier (URI); and providing identifiers of the data objects linked to the selected node to the one or more web services. In another particular implementation, block 410 may apply a selected analytical tool to data objects in the memory linked to the node selected at block 404 by executing one or more computer programs hosted on computing device hosting the GUI.

In block 476 (FIG. 4C), following selection of a first node in a hierarchical graph responsive to receipt of first user inputs at block 474, second user inputs may be received at a GUI for selection of a second node in the hierarchical graph. As illustrated in the particular example of FIG. 3B, this may comprise selection of node 104 followed by selection of node 112 by positioning a cursor over node 112 and making a first mouse click, followed by positioning the cursor over node 114 and making a second mouse click. Following selection of a second node in the hierarchical graph responsive to receipt of first user inputs at block 476, block 478 may comprise presentation on a display device of data objects linked to the first and second nodes selected at blocks 474 and 476. As illustrated in the particular example of FIG. 3B, this may comprise generation of an image on a display device of a report (e.g., report 350) where data objects linked to the first node are listed in a first column (e.g., data objects linked to node 104 classified as relating to “bitcoin” shown listed in column 352) and data objects linked to the second node are listed in a second column (e.g., data objects linked to node 112 classified as relating to “NFT” shown listed in column 354). Data objects linked to both of the selected first and second nodes (e.g., classified as relating to “bitcoin” and “NFT”) may be presented in a third column of the report (e.g., column 356).

In process 450 (FIG. 4B), block 452 may comprise a process of creating an ontology, taxonomy and/or hierarchical structure for construction of a hierarchical graph such as hierarchical graph 100 shown in FIGS. 1A and 1B. Block 454 may comprise associating data objects with a node in the hierarchical graph constructed at block 452. For example, block 454 may comprise execution of a search to locate a complete set of data objects to be associated with a root node in the hierarchical graph (e.g., locating/identifying data objects categorized by classification “financial payments” for data objects to be linked to root node 102). Block 454 may also determine which subsets of data objects linked to a root node that are to be linked to corresponding descending nodes in the graph (e.g., identifying which objects categorized by classification “financial payments” are also categorized by “bitcoin,” “cryptocurrency,” “mobile payments,” “blockchain” or “NFT” for respective nodes 104, 106, 108, 110 or 112). Block 456 may be performed response to selection of an icon shown in menu 200 to apply an associated selected analytical tool to data objects linked to a selected node. Results may then be present on a display device and/or computer screen (e.g. as shown in FIG. 3). At block 458, a user may then review the presented results from application of the selected analytical tool on data objects linked to the selected node.

In the context of the present patent application, the term “connection,” the term “component” and/or similar terms are intended to be physical, but are not necessarily always tangible. Whether or not these terms refer to tangible subject matter, thus, may vary in a particular context of usage. As an example, a tangible connection and/or tangible connection path may be made, such as by a tangible, electrical connection, such as an electrically conductive path comprising metal or other conductor, that is able to conduct electrical current between two tangible components. Likewise, a tangible connection path may be at least partially affected and/or controlled, such that, as is typical, a tangible connection path may be open or closed, at times resulting from influence of one or more externally derived signals, such as external currents and/or voltages, such as for an electrical switch. Non-limiting illustrations of an electrical switch include a transistor, a diode, etc. However, a “connection” and/or “component,” in a particular context of usage, likewise, although physical, can also be non-tangible, such as a connection between a client and a server over a network, particularly a wireless network, which generally refers to the ability for the client and server to transmit, receive, and/or exchange communications, as discussed in more detail later.

In a particular context of usage, such as a particular context in which tangible components are being discussed, therefore, the terms “coupled” and “connected” are used in a manner so that the terms are not synonymous. Similar terms may also be used in a manner in which a similar intention is exhibited. Thus, “connected” is used to indicate that two or more tangible components and/or the like, for example, are tangibly in direct physical contact. Thus, using the previous example, two tangible components that are electrically connected are physically connected via a tangible electrical connection, as previously discussed. However, “coupled,” is used to mean that potentially two or more tangible components are tangibly in direct physical contact. Nonetheless, “coupled” is also used to mean that two or more tangible components and/or the like are not necessarily tangibly in direct physical contact, but are able to co-operate, liaise, and/or interact, such as, for example, by being “optically coupled.” Likewise, the term “coupled” is also understood to mean indirectly connected. It is further noted, in the context of the present patent application, since memory, such as a memory component and/or memory states, is intended to be non-transitory, the term physical, at least if used in relation to memory necessarily implies that such memory components and/or memory states, continuing with the example, are tangible.

Unless otherwise indicated, in the context of the present patent application, the term “or” if used to associate a list, such as A, B, or C, is intended to mean A, B, and C, here used in the inclusive sense, as well as A, B, or C, here used in the exclusive sense. With this understanding, “and” is used in the inclusive sense and intended to mean A, B, and C; whereas “and/or” can be used in an abundance of caution to make clear that all of the foregoing meanings are intended, although such usage is not required. In addition, the term “one or more” and/or similar terms is used to describe any feature, structure, characteristic, and/or the like in the singular, “and/or” is also used to describe a plurality and/or some other combination of features, structures, characteristics, and/or the like. Likewise, the term “based on” and/or similar terms are understood as not necessarily intending to convey an exhaustive list of factors, but to allow for existence of additional factors not necessarily expressly described.

The terms “correspond”, “reference”, “associate”, and/or similar terms relate to signals, signal samples and/or states, e.g., components of a signal measurement vector, which may be stored in memory and/or employed with operations to generate results, depending, at least in part, on the above-mentioned, signal samples and/or signal sample states. For example, a signal sample measurement vector may be stored in a memory location and further referenced wherein such a reference may be embodied and/or described as a stored relationship. A stored relationship may be employed by associating (e.g., relating) one or more memory addresses to one or more another memory addresses, for example, and may facilitate an operation, involving, at least in part, a combination of signal samples and/or states stored in memory, such as for processing by a processor and/or similar device, for example. Thus, in a particular context, “associating,” “referencing,” and/or “corresponding” may, for example, refer to an executable process of accessing memory contents of two or more memory locations, e.g., to facilitate execution of one or more operations among signal samples and/or states, wherein one or more results of the one or more operations may likewise be employed for additional processing, such as in other operations, or may be stored in the same or other memory locations, as may, for example, be directed by executable instructions. Furthermore, terms “fetching” and “reading” or “storing” and “writing” are to be understood as interchangeable terms for the respective operations, e.g., a result may be fetched (or read) from a memory location; likewise, a result may be stored in (or written to) a memory location.

It is further noted that the terms “type” and/or “like,” if used, such as with a feature, structure, characteristic, and/or the like, using “optical” or “electrical” as simple examples, means at least partially of and/or relating to the feature, structure, characteristic, and/or the like in such a way that presence of minor variations, even variations that might otherwise not be considered fully consistent with the feature, structure, characteristic, and/or the like, do not in general prevent the feature, structure, characteristic, and/or the like from being of a “type” and/or being “like,” (such as being an “optical-type” or being “optical-like,” for example) if the minor variations are sufficiently minor so that the feature, structure, characteristic, and/or the like would still be considered to be substantially present with such variations also present. Thus, continuing with this example, the terms optical-type and/or optical-like properties are necessarily intended to include optical properties. Likewise, the terms electrical-type and/or electrical-like properties, as another example, are necessarily intended to include electrical properties. It should be noted that the specification of the present patent application merely provides one or more illustrative examples and claimed subject matter is intended to not be limited to one or more illustrative examples; however, again, as has always been the case with respect to the specification of a patent application, particular context of description and/or usage provides helpful guidance regarding reasonable inferences to be drawn.

With advances in technology, it has become more typical to employ distributed computing and/or communication approaches in which portions of a process, such as signal processing of signal samples, for example, may be allocated among various devices, including one or more client devices and/or one or more server devices, via a computing and/or communications network, for example. A network may comprise two or more devices, such as network devices and/or computing devices, and/or may couple devices, such as network devices and/or computing devices, so that signal communications, such as in the form of signal packets and/or signal frames (e.g., comprising one or more signal samples), for example, may be exchanged, such as between a server device and/or a client device, as well as other types of devices, including between wired and/or wireless devices coupled via a wired and/or wireless network, for example.

An example of a distributed computing system comprises the so-called Hadoop distributed computing system, which employs a map-reduce type of architecture. In the context of the present patent application, the terms map-reduce architecture and/or similar terms are intended to refer to a distributed computing system implementation and/or embodiment for processing and/or for generating larger sets of signal samples employing map and/or reduce operations for a parallel, distributed process performed over a network of devices. A map operation and/or similar terms refer to processing of signals (e.g., signal samples) to generate one or more key-value pairs and to distribute the one or more pairs to one or more devices of the system (e.g., network). A reduce operation and/or similar terms refer to processing of signals (e.g., signal samples) via a summary operation (e.g., such as counting the number of students in a queue, yielding name frequencies, etc.). A system may employ such an architecture, such as by marshaling distributed server devices, executing various tasks in parallel, and/or managing communications, such as signal transfers, between various parts of the system (e.g., network), in an embodiment. As mentioned, one non-limiting, but well-known, example comprises the Hadoop distributed computing system. It refers to an open source implementation and/or embodiment of a map-reduce type architecture (available from the Apache Software Foundation, 1901 Munsey Drive, Forrest Hill, MD, 21050-2747), but may include other aspects, such as the Hadoop distributed file system (HDFS) (available from the Apache Software Foundation, 1901 Munsey Drive, Forrest Hill, MD, 21050-2747). In general, therefore, “Hadoop” and/or similar terms (e.g., “Hadoop-type,” etc.) refer to an implementation and/or embodiment of a scheduler for executing larger processing jobs using a map-reduce architecture over a distributed system. Furthermore, in the context of the present patent application, use of the term “Hadoop” is intended to include versions, presently known and/or to be later developed.

In the context of the present patent application, the term network device refers to any device capable of communicating via and/or as part of a network and may comprise a computing device. While network devices may be capable of communicating signals (e.g., signal packets and/or frames), such as via a wired and/or wireless network, they may also be capable of performing operations associated with a computing device, such as arithmetic and/or logic operations, processing and/or storing operations (e.g., storing signal samples), such as in memory as tangible, physical memory states, and/or may, for example, operate as a server device and/or a client device in various embodiments. Network devices capable of operating as a server device, a client device and/or otherwise, may include, as examples, dedicated rack-mounted servers, desktop computers, laptop computers, set top boxes, tablets, netbooks, smart phones, wearable devices, integrated devices combining two or more features of the foregoing devices, and/or the like, or any combination thereof. As mentioned, signal packets and/or frames, for example, may be exchanged, such as between a server device and/or a client device, as well as other types of devices, including between wired and/or wireless devices coupled via a wired and/or wireless network, for example, or any combination thereof. It is noted that the terms, server, server device, server computing device, server computing platform and/or similar terms are used interchangeably. Similarly, the terms client, client device, client computing device, client computing platform and/or similar terms are also used interchangeably. While in some instances, for ease of description, these terms may be used in the singular, such as by referring to a “client device” or a “server device,” the description is intended to encompass one or more client devices and/or one or more server devices, as appropriate. Along similar lines, references to a “database” are understood to mean, one or more databases and/or portions thereof, as appropriate.

It should be understood that for ease of description, a network device (also referred to as a networking device) may be embodied and/or described in terms of a computing device and vice-versa. However, it should further be understood that this description should in no way be construed so that claimed subject matter is limited to one embodiment, such as only a computing device and/or only a network device, but, instead, may be embodied as a variety of devices or combinations thereof, including, for example, one or more illustrative examples.

A network may also include now known, and/or to be later developed arrangements, derivatives, and/or improvements, including, for example, past, present and/or future mass storage, such as network attached storage (NAS), a storage area network (SAN), and/or other forms of device readable media, for example. A network may include a portion of the Internet, one or more local area networks (LANs), one or more wide area networks (WANs), wire-line type connections, wireless type connections, other connections, or any combination thereof. Thus, a network may be worldwide in scope and/or extent. Likewise, sub-networks, such as may employ differing architectures and/or may be substantially compliant and/or substantially compatible with differing protocols, such as network computing and/or communications protocols (e.g., network protocols), may interoperate within a larger network.

The Internet refers to a decentralized global network of interoperable networks that comply with the Internet Protocol (IP). It is noted that there are several versions of the Internet Protocol. The term Internet Protocol, IP, and/or similar terms are intended to refer to any version, now known and/or to be later developed. The Internet includes local area networks (LANs), wide area networks (WANs), wireless networks, and/or long haul public networks that, for example, may allow signal packets and/or frames to be communicated between LANs. The term World Wide Web (WWW or Web) and/or similar terms may also be used, although it refers to a part of the Internet that complies with the Hypertext Transfer Protocol (HTTP). For example, network devices may engage in an HTTP session through an exchange of appropriately substantially compatible and/or substantially compliant signal packets and/or frames. It is noted that there are several versions of the Hypertext Transfer Protocol. The term Hypertext Transfer Protocol, HTTP, and/or similar terms are intended to refer to any version, now known and/or to be later developed. It is likewise noted that in various places in this document substitution of the term Internet with the term World Wide Web (“Web”) may be made without a significant departure in meaning and may, therefore, also be understood in that manner if the statement would remain correct with such a substitution.

The term electronic file and/or the term electronic document are used throughout this document to refer to a set of stored memory states and/or a set of physical signals associated in a manner so as to thereby at least logically form a file (e.g., electronic) and/or an electronic document. That is, it is not meant to implicitly reference a particular syntax, format and/or approach used, for example, with respect to a set of associated memory states and/or a set of associated physical signals. If a particular type of file storage format and/or syntax, for example, is intended, it is referenced expressly. It is further noted that an association of memory states, for example, may be in a logical sense and not necessarily in a tangible, physical sense. Thus, although signal and/or state components of a file and/or an electronic document, for example, are to be associated logically, storage thereof, for example, may reside in one or more different places in a tangible, physical memory, in an embodiment.

A Hyper Text Markup Language (“HTML”), for example, may be utilized to specify digital content and/or to specify a format thereof, such as in the form of an electronic file and/or an electronic document, such as a Web page, Web site, etc., for example. An Extensible Markup Language (“XML”) may also be utilized to specify digital content and/or to specify a format thereof, such as in the form of an electronic file and/or an electronic document, such as a Web page, Web site, etc., in an embodiment. Of course, HTML and/or XML are merely examples of “markup” languages, provided as non-limiting illustrations. Furthermore, HTML and/or XML are intended to refer to any version, now known and/or to be later developed, of these languages. Likewise, claimed subject matter are not intended to be limited to examples provided as illustrations, of course.

In the context of the present patent application, the terms “entry,” “electronic entry,” “document,” “electronic document,” “content,”, “digital content,” “item,” and/or similar terms are meant to refer to signals and/or states in a physical format, such as a digital signal and/or digital state format, e.g., that may be perceived by a user if displayed, played, tactilely generated, etc. and/or otherwise executed by a device, such as a digital device, including, for example, a computing device, but otherwise might not necessarily be readily perceivable by humans (e.g., if in a digital format). Likewise, in the context of the present patent application, digital content provided to a user in a form so that the user is able to readily perceive the underlying content itself (e.g., content presented in a form consumable by a human, such as hearing audio, feeling tactile sensations and/or seeing images, as examples) is referred to, with respect to the user, as “consuming” digital content, “consumption” of digital content, “consumable” digital content and/or similar terms. In another embodiment, an electronic document, electronic content and/or digital content may comprise text, audio and/or image content formatted to be processed by a generative neural network model, or text, audio and/or image content generated by a generative neural network model. For one or more embodiments, an electronic document and/or an electronic file may comprise a Web page of code (e.g., computer instructions) in a markup language executed or to be executed by a computing and/or networking device, for example. In another embodiment, an electronic document and/or electronic file may comprise a portion and/or a region of a Web page. However, claimed subject matter is not intended to be limited in these respects.

Also, for one or more embodiments, an electronic document and/or electronic file may comprise a number of components. As previously indicated, in the context of the present patent application, a component is physical, but is not necessarily tangible. As an example, components with reference to an electronic document and/or electronic file, in one or more embodiments, may comprise text, for example, in the form of physical signals and/or physical states (e.g., capable of being physically displayed). Typically, memory states, for example, comprise tangible components, whereas physical signals are not necessarily tangible, although signals may become (e.g., be made) tangible, such as if appearing on a tangible display, for example, as is not uncommon. Also, for one or more embodiments, components with reference to an electronic document and/or electronic file may comprise a graphical object, such as, for example, an image, such as a digital image, and/or sub-objects, including attributes thereof, which, again, comprise physical signals and/or physical states (e.g., capable of being tangibly displayed). In an embodiment, digital content may comprise, for example, text, images, audio, video, and/or other types of electronic documents and/or electronic files, including portions thereof, for example.

Also, in the context of the present patent application, the term parameters (e.g., one or more parameters) refer to material descriptive of a collection of signal samples, such as one or more electronic documents and/or electronic files, and exist in the form of physical signals and/or physical states, such as memory states. For example, one or more parameters, such as referring to an electronic document and/or an electronic file comprising an image, may include, as examples, time of day at which an image was captured, latitude and longitude of an image capture device, such as a camera, for example, etc. In another example, one or more parameters relevant to digital content, such as digital content comprising a technical article, as an example, may include one or more authors, for example. Claimed subject matter is intended to embrace meaningful, descriptive parameters in any format, so long as the one or more parameters comprise physical signals and/or states, which may include, as parameter examples, collection name (e.g., electronic file and/or electronic document identifier name), technique of creation, purpose of creation, time and date of creation, logical path if stored, coding formats (e.g., type of computer instructions, such as a markup language) and/or standards and/or specifications used so as to be protocol compliant (e.g., meaning substantially compliant and/or substantially compatible) for one or more uses, and so forth.

Signal packet communications and/or signal frame communications, also referred to as signal packet transmissions and/or signal frame transmissions (or merely “signal packets” or “signal frames”), may be communicated between nodes of a network, where a node may comprise one or more network devices and/or one or more computing devices, for example. As an illustrative example, but without limitation, a node may comprise one or more sites employing a local network address, such as in a local network address space. Likewise, a device, such as a network device and/or a computing device, may be associated with that node. It is also noted that in the context of this patent application, the term “transmission” is intended as another term for a type of signal communication that may occur in any one of a variety of situations. Thus, it is not intended to imply a particular directionality of communication and/or a particular initiating end of a communication path for the “transmission” communication. For example, the mere use of the term in and of itself is not intended, in the context of the present patent application, to have particular implications with respect to the one or more signals being communicated, such as, for example, whether the signals are being communicated “to” a particular device, whether the signals are being communicated “from” a particular device, and/or regarding which end of a communication path may be initiating communication, such as, for example, in a “push type” of signal transfer or in a “pull type” of signal transfer. In the context of the present patent application, push and/or pull type signal transfers are distinguished by which end of a communications path initiates signal transfer.

Thus, a signal packet and/or frame may, as an example, be communicated via a communication channel and/or a communication path, such as comprising a portion of the Internet and/or the Web, from a site via an access node coupled to the Internet or vice-versa. Likewise, a signal packet and/or frame may be forwarded via network nodes to a target site coupled to a local network, for example. A signal packet and/or frame communicated via the Internet and/or the Web, for example, may be routed via a path, such as either being “pushed” or “pulled,” comprising one or more gateways, servers, etc. that may, for example, route a signal packet and/or frame, such as, for example, substantially in accordance with a target and/or destination address and availability of a network path of network nodes to the target and/or destination address. Although the Internet and/or the Web comprise a network of interoperable networks, not all of those interoperable networks are necessarily available and/or accessible to the public.

A network and/or sub-network, in an embodiment, may communicate via signal packets and/or signal frames, such as via participating digital devices and may be substantially compliant and/or substantially compatible with, but is not limited to, now known and/or to be developed, versions of any of the following network protocol stacks: ARCNET, AppleTalk, ATM, Bluetooth, DECnet, Ethernet, FDDI, Frame Relay, HIPPI, IEEE 1394, IEEE 802.11, IEEE-488, Internet Protocol Suite, IPX, Myrinet, OSI Protocol Suite, QsNet, RS-232, SPX, System Network Architecture, Token Ring, USB, and/or X.25. A network and/or sub-network may employ, for example, a version, now known and/or later to be developed, of the following: TCP/IP, UDP, DECnet, NetBEUI, IPX, AppleTalk and/or the like. Versions of the Internet Protocol (IP) may include IPv4, IPv6, and/or other later to be developed versions.

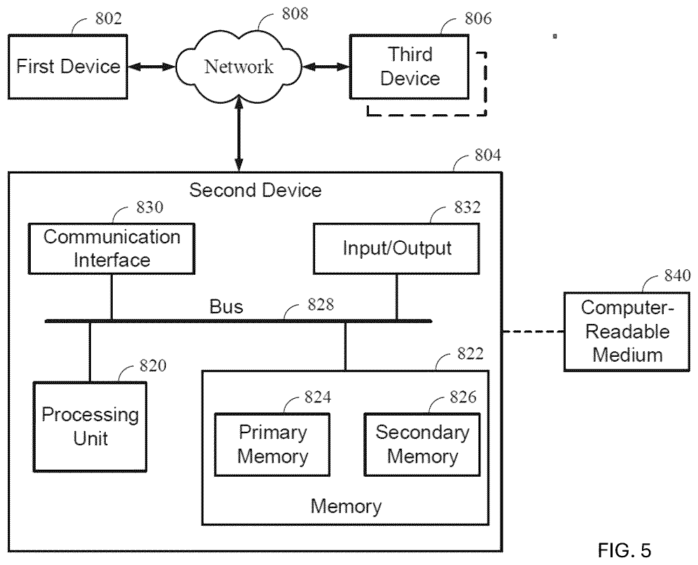

In one example embodiment, as shown in FIG. 5, a system embodiment may comprise a local network (e.g., device 804 and medium 840) and/or another type of network, such as a computing and/or communications network. For purposes of illustration, therefore, FIG. 5 shows an embodiment 800 of a system that may be employed to implement either type or both types of networks. Network 808 may comprise one or more network connections, links, processes, services, applications, and/or resources to facilitate and/or support communications, such as an exchange of communication signals, for example, between a computing device, such as 802, and another computing device, such as 806, which may, for example, comprise one or more client computing devices and/or one or more server computing device. By way of example, but not limitation, network 808 may comprise wireless and/or wired communication links, telephone and/or telecommunications systems, Wi-Fi networks, Wi-MAX networks, the Internet, a local area network (LAN), a wide area network (WAN), or any combinations thereof.

Example devices in FIG. 5 may comprise features, for example, of a client computing device and/or a server computing device, in an embodiment. It is further noted that the term computing device, in general, whether employed as a client and/or as a server, or otherwise, refers at least to a processor and a memory connected by a communication bus. A “processor,” for example, is understood to connote a specific structure such as a central processing unit (CPU) of a computing device which may include a control unit and an execution unit. In an aspect, a processor may comprise a device that fetches, interprets and executes instructions to process input signals to provide output signals. As such, in the context of the present patent application at least, computing device and/or processor are understood to refer to sufficient structure within the meaning of 35 USC § 112 (f) so that it is specifically intended that 35 USC § 112 (f) not be implicated by use of the term “computing device,” “processor” and/or similar terms; however, if it is determined, for some reason not immediately apparent, that the foregoing understanding cannot stand and that 35 USC § 112 (f), therefore, necessarily is implicated by the use of the term “computing device,” “processor” and/or similar terms, then, it is intended, pursuant to that statutory section, that corresponding structure, material and/or acts for performing one or more functions be understood and be interpreted to be described at least in FIGS. 1A, 1B, 2, 3A, 3B, 4A, 4B and 4C, and in the text associated with the foregoing figure(s) of the present patent application.

Referring now to FIG. 5, in an embodiment, first and third devices 802 and 806 may be capable of rendering a graphical user interface (GUI) (e.g., including a pointer device) for a network device and/or a computing device, for example, so that a user-operator may engage in system use. Computing device 804 may potentially serve a similar function in this illustration. Likewise, in FIG. 5, computing device 802 (‘first device’ in figure) may interface with computing device 804 (‘second device’ in figure), which may, for example, also comprise features of a client computing device and/or a server computing device, in an embodiment. Processor (e.g., processing device) 820 and memory 822, which may comprise primary memory 824 and secondary memory 826, may communicate by way of a communication bus 815, for example. The term “computing device,” in the context of the present patent application, refers to a system and/or a device, such as a computing apparatus, that includes a capability to process (e.g., perform computations) and/or store digital content, such as electronic files, electronic documents, measurements, text, images, video, audio, etc. in the form of signals and/or states. Thus, a computing device, in the context of the present patent application, may comprise hardware, software, firmware, or any combination thereof (other than software per se). Computing device 804, as depicted in FIG. 5, is merely one example, and claimed subject matter is not limited in scope to this particular example.

For one or more embodiments, a device, such as a computing device and/or networking device, may comprise, for example, any of a wide range of digital electronic devices, including, but not limited to, desktop and/or notebook computers, high-definition televisions, digital versatile disc (DVD) and/or other optical disc players and/or recorders, game consoles, satellite television receivers, cellular telephones, tablet devices, wearable devices, personal digital assistants, mobile audio and/or video playback and/or recording devices, Internet of Things (IOT) type devices, or any combination of the foregoing. Further, unless specifically stated otherwise, a process as described, such as with reference to flow diagrams and/or otherwise, may also be executed and/or affected, in whole or in part, by a computing device and/or a network device. A device, such as a computing device and/or network device, may vary in terms of capabilities and/or features. Claimed subject matter is intended to cover a wide range of potential variations. For example, a device may include a numeric keypad and/or other display of limited functionality, such as a monochrome liquid crystal display (LCD) for displaying text, for example. In contrast, however, as another example, a web-enabled device may include a physical and/or a virtual keyboard, mass storage, one or more accelerometers, one or more gyroscopes, global positioning system (GPS) and/or other location-identifying type capability, and/or a display with a higher degree of functionality, such as a touch-sensitive color 2D or 3D display, for example.

As suggested previously, communications between a computing device and/or a network device and a wireless network may be in accordance with known and/or to be developed network protocols including, for example, global system for mobile communications (GSM), enhanced data rate for GSM evolution (EDGE), 802.11b/g/n/h, etc., and/or worldwide interoperability for microwave access (WiMAX). A computing device and/or a networking device may also have a subscriber identity module (SIM) card, which, for example, may comprise a detachable or embedded smart card that is able to store subscription content of a user, and/or is also able to store a contact list. It is noted, however, that a SIM card may also be electronic, meaning that it may simply be stored in a particular location in memory of the computing and/or networking device. A user may own the computing device and/or network device or may otherwise be a user, such as a primary user, for example. A device may be assigned an address by a wireless network operator, a wired network operator, and/or an Internet Service Provider (ISP). For example, an address may comprise a domestic or international telephone number, an Internet Protocol (IP) address, and/or one or more other identifiers. In other embodiments, a computing and/or communications network may be embodied as a wired network, wireless network, or any combinations thereof.

A computing and/or network device may include and/or may execute a variety of now known and/or to be developed operating systems, derivatives and/or versions thereof, including computer operating systems, such as Windows, iOS, Linux, a mobile operating system, such as iOS, Android, Windows Mobile, and/or the like. A computing device and/or network device may include and/or may execute a variety of possible applications, such as a client software application enabling communication with other devices. A computing and/or network device may also include executable computer instructions to process and/or communicate digital content. A computing and/or network device may also include executable computer instructions to perform a variety of possible tasks, such as browsing, searching, playing various forms of digital content, including locally stored and/or streamed video, and/or games such as, but not limited to, fantasy sports leagues. A computing and/or network device may also process input content as a prompt to one or more generative neural network models to provide output content. A computing and/or network device may also perform linguistic processing such as applying transforms to determine an embedding of tokens and/or apply attention models to determine service codes. The foregoing is provided merely to illustrate that claimed subject matter is intended to include a wide range of possible features and/or capabilities.

In FIG. 5, computing device 802 may provide one or more sources of executable computer instructions in the form physical states and/or signals (e.g., stored in memory states), for example. Computing device 802 may communicate with computing device 804 by way of a network connection, such as via network 808, for example. As previously mentioned, a connection, while physical, may not necessarily be tangible. Although computing device 804 of FIG. 7 shows various tangible, physical components, claimed subject matter is not limited to computing devices having only these tangible components as other implementations and/or embodiments may include alternative arrangements that may comprise additional tangible components or fewer tangible components, for example, that function differently while achieving similar results. Rather, examples are provided merely as illustrations. It is not intended that claimed subject matter be limited in scope to illustrative examples.

Memory 822 may comprise any non-transitory storage mechanism. Memory 822 may comprise, for example, primary memory 824 and secondary memory 826, additional memory circuits, mechanisms, or combinations thereof may be used. Memory 822 may comprise, for example, random access memory, read only memory, etc., such as in the form of one or more storage devices and/or systems, such as, for example, a disk drive including an optical disc drive, a tape drive, a solid-state memory drive, etc., just to name a few examples.

Memory 822 may be utilized to store a program of executable computer instructions. For example, processor 820 may fetch executable instructions from memory and proceed to interpret and execute the fetched instructions. Memory 822 may also comprise a memory controller for accessing device readable-medium 840 that may carry and/or make accessible digital content, which may include code, and/or instructions, for example, executable by processor 820 and/or some other device, such as a controller, as one example, capable of executing computer instructions, for example. Under direction of processor 820, a non-transitory memory, such as memory cells storing physical states (e.g., memory states), comprising, for example, a program of executable computer instructions, may be executed by processor 820 and able to generate signals to be communicated via a network, for example, as previously described. Generated signals may also be stored in memory, also previously suggested. In a particular implementation, processor 820 may include general processing cores and/or specialized co-processing cores (e.g., signal processors, graphical processing unit (GPU) and/or neural network processing unit (NPU)), for example.

Memory 822 may store electronic files and/or electronic documents, such as relating to one or more users, and may also comprise a computer-readable medium that may carry and/or make accessible content, including code and/or instructions, for example, executable by processor 820 and/or some other device, such as a controller, as one example, capable of executing computer instructions, for example. As previously mentioned, the term electronic file and/or the term electronic document are used throughout this document to refer to a set of stored memory states and/or a set of physical signals associated in a manner so as to thereby form an electronic file and/or an electronic document. That is, it is not meant to implicitly reference a particular syntax, format and/or approach used, for example, with respect to a set of associated memory states and/or a set of associated physical signals. It is further noted that an association of memory states, for example, may be in a logical sense and not necessarily in a tangible, physical sense. Thus, although signal and/or state components of an electronic file and/or electronic document, are to be associated logically, storage thereof, for example, may reside in one or more different places in a tangible, physical memory, in an embodiment.

Algorithmic descriptions and/or symbolic representations are examples of techniques used by those of ordinary skill in the signal processing and/or related arts to convey the substance of their work to others skilled in the art. An algorithm is, in the context of the present patent application, and generally, is considered to be a self-consistent sequence of operations and/or similar signal processing leading to a desired result. In the context of the present patent application, operations and/or processing involve physical manipulation of physical quantities. Typically, although not necessarily, such quantities may take the form of electrical and/or magnetic signals and/or states capable of being stored, transferred, combined, compared, processed and/or otherwise manipulated, for example, as electronic signals and/or states making up components of various forms of digital content, such as signal measurements, text, images, video, audio, etc.

It has proven convenient at times, principally for reasons of common usage, to refer to such physical signals and/or physical states as bits, service codes, tokens, computed likelihoods, values, elements, parameters, symbols, characters, terms, numbers, numerals, measurements, content and/or the like. It should be understood, however, that all of these and/or similar terms are to be associated with appropriate physical quantities and are merely convenient labels. Unless specifically stated otherwise, as apparent from the preceding discussion, it is appreciated that throughout this specification discussions utilizing terms such as “processing,” “computing,” “calculating,” “determining”, “establishing”, “obtaining”, “identifying”, “selecting”, “generating”, and/or the like may refer to actions and/or processes of a specific apparatus, such as a special purpose computer and/or a similar special purpose computing and/or network device. In the context of this specification, therefore, a special purpose computer and/or a similar special purpose computing and/or network device is capable of processing, manipulating and/or transforming signals and/or states, typically in the form of physical electronic and/or magnetic quantities, within memories, registers, and/or other storage devices, processing devices, and/or display devices of the special purpose computer and/or similar special purpose computing and/or network device. In the context of this particular patent application, as mentioned, the term “specific apparatus” therefore includes a general purpose computing and/or network device, such as a general purpose computer, once it is programmed to perform particular functions, such as pursuant to program software instructions.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and/or storage of charge or a release of stored charge. Likewise, in other memory devices, a change of state may comprise a physical change, such as a transformation in magnetic orientation. Likewise, a physical change may comprise a transformation in molecular structure, such as from crystalline form to amorphous form or vice-versa. In still other memory devices, a change in physical state may involve quantum mechanical phenomena, such as superposition, entanglement, and/or the like, which may involve quantum bits (qubits), for example. The foregoing is not intended to be an exhaustive list of all examples in which a change in state from a binary one to a binary zero or vice-versa in a memory device may comprise a transformation, such as a physical, but non-transitory, transformation. Rather, the foregoing is intended as illustrative examples.

Referring again to FIG. 5, processor 820 may comprise one or more circuits, such as digital circuits, to perform at least a portion of a computing procedure and/or process. By way of example, but not limitation, processor 820 may comprise one or more processors, such as controllers, microprocessors, microcontrollers, application specific integrated circuits, GPUs, NPUs, digital signal processors, programmable logic devices, field programmable gate arrays, the like, or any combination thereof. In various implementations and/or embodiments, processor 820 may perform signal processing, typically substantially in accordance with fetched executable computer instructions, such as to manipulate signals and/or states, to construct signals and/or states, etc., with signals and/or states generated in such a manner to be communicated and/or stored in memory, for example.

FIG. 5 also illustrates device 804 as including a component 832 operable with input/output devices, for example, so that signals and/or states may be appropriately communicated between devices, such as device 804 and an input device and/or device 804 and an output device. A user may make use of an input device, such as a computer mouse, stylus, track ball, microphone, scanner, keyboard, and/or any other similar device capable of receiving user actions and/or motions as input signals. Likewise, for a device having speech to text capability, a user may speak to a device to generate input signals. A user may make use of an output device, such as a display, a printer, etc., and/or any other device capable of providing signals and/or generating stimuli for a user, such as visual stimuli, audio stimuli and/or other similar stimuli.

In the preceding description, various aspects of claimed subject matter have been described. For purposes of explanation, specifics, such as amounts, systems and/or configurations, as examples, were set forth. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all modifications and/or changes as fall within claimed subject matter.

Some embodiments may be described, at least in part, by the following numbered clauses or by any combination thereof:

Clause 1: An apparatus, comprising:
a display device; and
one or more processors to:
   initiate presentation of images on the display device including a hierarchical graph, the hierarchical graph comprising nodes connected by edges descending from a root node, each node in the graph to be electronically linked to a set of data objects maintained in a memory;
   obtain first user inputs via a graphical user interface (GUI) integrated with the display device to select a first node in the hierarchical graph;
   obtain second user inputs via the GUI to select a second node in the hierarchical graph; and
   responsive at least in part to selection of the first and second nodes, initiate presentation on the display device a list of data objects linked to the first and second nodes.

Clause 2: The apparatus of clause 1, wherein the instructions are further executable by the one or more processors to:
obtain user inputs via the GUI to select three or more nodes in the hierarchical graph in succession; and
   responsive at least in part to the selection of the three or more nodes in the hierarchical graph in succession, initiate presentation on the display device of a list of objects linked to each of the selected nodes.

Clause 3: An article, comprising:
a storage medium comprising computer-readable instructions stored thereon, the instructions to be executable by one or more processors of a computing device to:
initiate presentation of images on a display device including a hierarchical graph, the hierarchical graph comprising nodes connected by edges descending from a root node, each node in the graph to be electronically linked to a set of data objects maintained in a memory, each child node in the graph descending from a parent node in the graph to be linked to data objects in the memory which are a subset of the data objects in the memory linked to the parent node according to one or more classification attributes to be defined for the child node;
obtain first user inputs via a graphical user interface (GUI) integrated with the display device to select a node in the hierarchical graph;
responsive to the selection of the node, present a menu of a plurality of analytical tools on the display device;
obtain second user inputs via the GUI to select an analytical tool of the plurality of analytical tools; and
responsive to the selection of the analytical tool of the plurality of analytical tools, apply the selected analytical tool to data objects in the memory linked to the selected node to compute an output report.

Clause 4: The article of clause 3, the instructions to be further executable by the one or more processors to:
initiate presentation of at least a portion of the output report on the display device.

Clause 5: The article of clause 3, wherein:
the data objects comprise electronic documents; and
electronic documents linked to a node are accessible, at least in part, via the GUI by selection of the node.

Clause 6: The article of clause 3, wherein at least some of the nodes are linked to respective data objects via one more universal resource identifiers (URIs).

Clause 7: The article of clause 3, wherein at least some of the nodes are linked to respective data objects via addresses to electronic documents local to the computing device.

Clause 8: The article of clause 3, wherein application of the selected analytical tool to data objects in the memory linked to the selected node to compute the output report further comprises:
initiation of access to one or more web services via a universal resource identifier (URI); and
provide identifiers of the data objects linked to the selected node to the one or more web services.

Clause 9: The article of clause 3, wherein the data objects comprise publications of U.S. patents in an electronic format.

Clause 10: The article of clause 3, wherein application of the selected analytical tool to data objects in the memory linked to the selected node to compute the output report further comprises execution of one or more computer programs hosted on the computing device.

Clause 11: An article, comprising:
a storage medium comprising computer-readable instructions stored thereon, the instructions to be executable by one or more processors of a computing device to:
initiate presentation of images on a display device including a hierarchical graph, the hierarchical graph comprising nodes connected by edges descending from a root node, each node in the graph to be electronically linked to a set of data objects maintained in a memory;
obtain first user inputs via a graphical user interface (GUI) integrated with the display device to select a first node in the hierarchical graph;
obtain second user inputs via the GUI to select a second node in the hierarchical graph; and
responsive at least in part to selection of the first and second nodes, initiate presentation on the display device a list of data objects linked to the first and second nodes.

Clause 12: The article of clause 11, wherein the instructions are further executable by the one or more processors to:
obtain user inputs via the GUI to select three or more nodes in the hierarchical graph in succession; and
responsive at least in part to the selection of the three or more nodes in the hierarchical graph in succession, initiate presentation on the display device of a list of objects linked to each of the selected nodes.

What is claimed is:

1. A method, at a computing device, comprising:
presenting images on a display device including a hierarchical graph, the hierarchical graph comprising nodes connected by edges descending from a root node, each node in the hierarchical graph to be electronically linked to a set of data objects maintained in a memory, each child node in the hierarchical graph descending from a parent node in the hierarchical graph to be linked to data objects in the memory which are a subset of the data objects in the memory linked to the parent node according to one or more classification attributes to be defined for the child node;
receiving first user inputs via a graphical user interface (GUI) integrated with the display device to select a node in the hierarchical graph;
responsive to the selection of the node, presenting a menu of a plurality of analytical tools on the display device;
receiving second user inputs via the GUI to select an analytical tool of the plurality of analytical tools; and
responsive to the selection of the analytical tool of the plurality of analytical tools, applying the selected analytical tool to data objects in the memory linked to the selected node to compute an output report.

2. The method of claim 1, and further comprising:
presenting at least a portion of the output report on the display device.

3. The method of claim 1, wherein:
the data objects comprise electronic documents; and
electronic documents linked to a node are accessible, at least in part, via the GUI by selection of the node.

4. The method of claim 1, wherein at least some of the nodes are linked to respective data objects via one more universal resource identifiers (URIs).

5. The method of claim 1, wherein at least some of the nodes are linked to respective data objects via addresses to electronic documents local to the computing device.

6. The method of claim 1, wherein applying the selected analytical tool to data objects in the memory linked to the selected node to compute the output report further comprises:
initiating access to one or more web services via a universal resource identifier (URI); and
providing identifiers of the data objects linked to the selected node to the one or more web services.

7. The method of claim 1, wherein the data objects comprise publications of U.S. patents in an electronic format.

8. The method of claim 1, wherein applying the selected analytical tool to data objects in the memory linked to the selected node to compute the output report further comprises executing one or more computer programs hosted on the computing device.

9. A method, at a computing device, comprising:
presenting images on a display device including a hierarchical graph, the hierarchical graph comprising nodes connected by edges descending from a root node, each node in the hierarchical graph to be electronically linked to a set of data objects maintained in a memory;
receiving first user inputs via a graphical user interface (GUI) integrated with the display device to select a first node in the hierarchical graph;
receiving second user inputs via the GUI to select a second node in the hierarchical graph; and
responsive at least in part to selection of the first and second nodes, presenting on the display device a list of data objects linked to the first and second nodes.

10. The method of claim 9, and further comprising:
receiving user inputs via the GUI to select three or more nodes in the hierarchical graph in succession; and
responsive at least in part to the selection of the three or more nodes in the hierarchical graph in succession, presenting on the display device a list of objects linked to each of the selected nodes.

11. A computing device comprising:
a display device; and
one or more processors to:
initiate presentation of images on the display device including a hierarchical graph, the hierarchical graph comprising nodes connected by edges descending from a root node, each node in the hierarchical graph to be electronically linked to a set of data objects maintained in a memory, each child node in the hierarchical graph descending from a parent node in the hierarchical graph to be linked to data objects in the memory which are a subset of the data objects in the memory linked to the parent node according to one or more classification attributes to be defined for the child node;
obtain first user inputs via a graphical user interface (GUI) integrated with the display device to select a node in the hierarchical graph;
responsive to the selection of the node, present a menu of a plurality of analytical tools on the display device;
obtain second user inputs via the GUI to select an analytical tool of the plurality of analytical tools; and
responsive to the selection of the analytical tool of the plurality of analytical tools, apply the selected analytical tool to data objects in the memory linked to the selected node to compute an output report.

12. The computing device of claim 11, wherein the one or more processors are further to:
initiate presentation of at least a portion of the output report on the display device.

13. The computing device of claim 11, wherein:
the data objects comprise electronic documents; and
electronic documents linked to a node are accessible, at least in part, via the GUI by selection of the node.

14. The computing device of claim 11, wherein at least some of the nodes are linked to respective data objects via one more universal resource identifiers (URIs).

15. The computing device of claim 11, wherein at least some of the nodes are linked to respective data objects via addresses to electronic documents local to the computing device.

16. The computing device of claim 11, wherein application of the selected analytical tool to data objects in the memory linked to the selected node to compute the output report further comprises:
initiation of access to one or more web services via a universal resource identifier (URI); and
provide identifiers of the data objects linked to the selected node to the one or more web services.

17. The computing device of claim 11, wherein the data objects comprise publications of U.S. patents in an electronic format.

18. The computing device of claim 11, wherein application of the selected analytical tool to data objects in the memory linked to the selected node to compute the output report further comprises execution of one or more computer programs hosted on the computing device.
